(19) United States
(12) Patent Application Publication
(10) Pub. No.: US 2009/0021450 A1
(43) Pub. Date: Jan. 22, 2009

(54) Data synchronization of auxiliary display

(75) Inventors: Zeev Heller, Ganei Tikva (IL); Ilia Stolov, Holon (IL)

Correspondence Address: ABELMAN, FRAYNE & SCHWAB, 666 THIRD AVENUE, 10TH FLOOR, NEW YORK, NY, 10017, US

(73) Assignee: WINBOND ELECTRONICS CORPORATION

(21) Appl. No.: 11/880,212

(22) Filed: Jul. 19, 2007

(51) Int. Cl. G09G 5/14

(52) U.S. Cl. 345/1.3

(57) ABSTRACT

A computing apparatus includes a network interface, a Central Processing Unit (CPU), an auxiliary controller and an activation controller. The CPU has active and switched-off operational states and is arranged, when operating in the active operational state, to accept data from a communication network using the network interface. The auxiliary display module is connected to the CPU and is arranged, when the CPU is in the switched-off operational state, to display auxiliary information to a user based on the data accepted by the CPU. The activation controller is coupled to intermittently switch the CPU to the active operational state and to cause the CPU to update the data from the communication network, so as to update the auxiliary information displayed by the auxiliary display module.

### FIELD OF THE INVENTION

The present invention relates generally to computer systems, and particularly to methods and systems for operating auxiliary displays.

### BACKGROUND OF THE INVENTION

Some computer configurations use auxiliary display modules for displaying selected information when the computer is switched off or hibernating. For example, an auxiliary display module can display e-mail messages, calendar entries, news headlines and other information. Some auxiliary display modules comprise an auxiliary display that is separate from the primary display of the computer.

Windows Sideshow™ is a product family offered by Microsoft Corp. (Redmond, Wash.), which enables a variety of auxiliary display devices to be connected to Windows Vista™ applications. Auxiliary display modules that operate with Windows Sideshow are described, for example, by Fuller in “Auxiliary Display Platform in Longhorn,” Windows Hardware Engineering Conference (WinHEC) 2005, Seattle, Wash., Apr. 25-27, 2005, and by Polivy in “Building Remote and Integrated Auxiliary Display Devices for Windows SideShow,” WinHEC 2006, Seattle, Wash., May 23-25, 2006, which are incorporated herein by reference.

Some aspects of auxiliary display operation are described in the patent literature. For example, U.S. Patent Application Publication 2006/0007051, whose disclosure is incorporated herein by reference, describes a method and system for auxiliary display of information for a computing device. An auxiliary display is integrated with a computing system to provide an area where notifications can be peripherally presented off-screen. Whenever a background task sends a notification to the main display of the system, the notification may be redirected to appear instead on the auxiliary display. The auxiliary display may be placed on the central processor chassis or on the monitor border along with indicator lights to provide simple peripheral-vision notification. By pressing buttons, a user may obtain additional detailed follow-up information.

U.S. Patent Application Publication 2005/0243021, whose disclosure is incorporated herein by reference, describes an architecture by which application programs can provide data to auxiliary display devices for display to a user. A defined application layer allows programs to provide data to a service, which controls the output of data to an auxiliary display device and returns navigational data to the application upon appropriate user interaction with the device via actuators. The architecture further provides a protocol layer that allows various types of displays to serve as an auxiliary display.

Auxiliary display devices are also described in U.S. Pat. No. 7,030,837 and in U.S. Patent Application Publications 2005/0262302, 2005/0243019 and 2005/0243020, whose disclosures are incorporated herein by reference.

### SUMMARY OF THE INVENTION

Embodiments of the present invention provide a computing apparatus, including:

a network interface;

a Central Processing Unit (CPU), which has active and switched-off operational states and is arranged, when operating in the active operational state, to accept data from a communication network using the network interface;

an auxiliary display module, which is connected to the CPU and is arranged, when the CPU is in the switched-off operational state, to display auxiliary information to a user based on the data accepted by the CPU; and

an activation controller, which is coupled to intermittently switch the CPU to the active operational state and to cause the CPU to update the data from the communication network, so as to update the auxiliary information displayed by the auxiliary display module.

In some embodiments, the auxiliary display module is arranged to evaluate an update condition and to issue to the activation controller a request for updating the auxiliary information responsively to the update condition, and the activation controller is coupled to accept the request and, in response to the request, to switch the CPU to the active operational state. The auxiliary display module may be arranged to measure a time interval in which the CPU is in the switched-off operational state and to issue the request when the time interval exceeds a predetermined limit.

In another embodiment, the activation controller is coupled to switch the CPU to the active operational state at regular intervals. Additionally or alternatively, the activation controller is coupled to return the CPU to the switched-off operational state immediately after the auxiliary information has been updated. In a disclosed embodiment, the auxiliary display module is arranged to issue to the activation controller a notification indicating that the auxiliary information has been updated, and the activation controller is coupled to return the CPU to the switched-off operational state upon receiving the notification.

In yet another embodiment, the network interface has active and switched-off operational states, and the activation controller is coupled to switch the network interface to the active operational state when switching the CPU to the active operational state and to switch the network interface to the switched-off operational state when the CPU is in the switched-off operational state.

There is additionally provided, in accordance with an embodiment of the present invention, a computing method, including:

coupling a computer that includes a Central Processing Unit (CPU), having active and switched-off operational states, to a communication network so that the CPU accepts data from the communication network when the computer is operating in the active operational state;

when the CPU is in the switched-off operational state, operating an auxiliary display module in the computer so as to display to a user auxiliary information, which is based on the data accepted by the CPU; and

intermittently switching the CPU to the active operational state by an activation controller that is separate from the CPU, and causing the CPU to update the data from the communication network, so as to update the auxiliary information displayed by the auxiliary display module.

There is also provided, in accordance with an embodiment of the present invention, a computer software product for use in a computer that includes a Central Processing Unit (CPU), which has active and switched-off operational states and is coupled to accept data from a communication network when the CPU is operating in the active operational state, and an auxiliary display module, which displays to a user auxiliary information that is based on the data accepted by the CPU, the product including a computer-readable medium, in which program instructions are stored, which instructions, when read by an activation controller in the computer, cause the activation controller to intermittently switch the CPU to the active operational state and to cause the CPU to update the data from the communication network, so as to update the auxiliary information displayed by the auxiliary display module.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer having an auxiliary display, in accordance with an embodiment of the present invention; and

FIG. 2 is a flow chart that schematically illustrates a method for updating information displayed by an auxiliary display module, in accordance with an embodiment of the present invention.

### DETAILED DESCRIPTION OF EMBODIMENTS

### Overview

Low power consumption is a prime consideration in the design of many computing platforms. Reducing power consumption increases the computer's battery life, reduces heat generation, increases the reliability of the computer and helps to comply with environmental standards. A significant portion of the power consumed by the computer is due to the Central Processing Unit (CPU) and its peripheral components, particularly when these devices operate at high clock rates.

In order to conserve power, computers often have one or more predefined switched-off operational states, in which the CPU and its peripheral components, as well as other elements of the computer, are deactivated.

Embodiments of the present invention provide methods and systems for updating the information displayed by an auxiliary display module, while minimizing the power consumption of the computer and providing continuous updates of information to the user. In the embodiments that are described hereinbelow, a computer comprises a Central Processing Unit (CPU), which has active and switched-off operational states. Switched-off states may comprise, for example, states or modes in which the computer is turned off, in sleep mode, hibernating or standing by. The computer comprises an Embedded Controller (EC), also referred to herein as an activation controller, which switches the CPU between the active and switched-off operational states. The computer further comprises an auxiliary display module, which displays auxiliary information to a user when the CPU is switched-off.

When the CPU is active, it receives data from a communication network, using a wired or wireless network adapter or other network interface, for example. The auxiliary information displayed by the auxiliary display controller is often based on the data received from the network by the CPU. When the CPU is switched-off, however, data is not received and the displayed auxiliary information may become outdated.

In order to maintain the auxiliary information up-to-date, the EC occasionally switches the CPU to the active state, thereby causing the CPU to receive up-to-date data from the communication network. For example, the EC may activate the CPU at regular intervals. Typically, the auxiliary display module triggers the EC with requests for updating the auxiliary information, and the EC activates the CPU in response to these requests. In addition to the CPU, the EC may activate and deactivate additional computer components and peripherals, such as the network interface, in order to further control power consumption.

When using the methods and systems described herein, the auxiliary information displayed to the user is constantly kept up-to-date. Since the CPU and its peripheral components are activated only intermittently and for short periods of time, the power consumption of the computer is considerably reduced.

### System Description

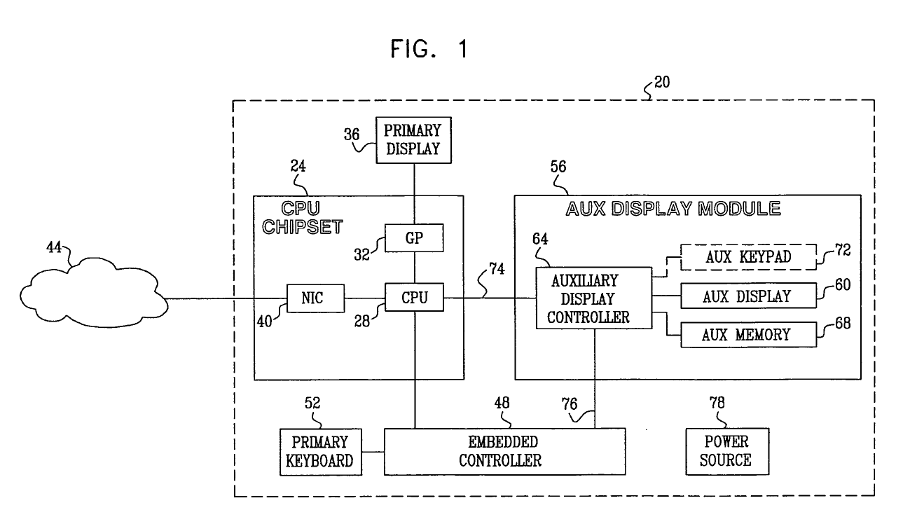

FIG. 1 is a block diagram that schematically illustrates a computer 20, in accordance with an embodiment of the present invention. Computer 20 may comprise a laptop, notebook or tablet computer, a desktop computer, an ultra-mobile computing device, or any other suitable computing platform.

Computer 20 comprises a Central Processing Unit (CPU) chipset 24. Chipset 24 comprises a CPU 28 and other components that are normally used for PC implementation, which carry out the different computing tasks of the computer. CPU 28 displays information on a primary display 36 using a Graphic Processor (GP) 32. In order to conserve power, CPU 28 can alternate between active and switched-off operational states.

CPU 28 communicates with a communication network 44 using a network interface 40. Network 44 may comprise, for example, a Wide Area Network (WAN) such as the Internet, a Metropolitan Area Network (MAN), a Local Area Network (LAN), an intranet of a certain organization, a telephony network such as a Public Switched Telephone Network (PSTN), a cellular network or any other suitable communication network. Network interface 40 may comprise, for example, a Network Interface Card (NIC), a modem, a network adapter or any other suitable interface for communicating with network 44. The network interface may be wired or wireless. In some cases, some or all of the network interface functionality may be embodied in chipset 24 itself.

Computer 20 comprises an Embedded Controller (EC) 48, which performs various power management functions of the computer, and in particular activates and deactivates different computer components, as appropriate. In particular, EC 48 activates and deactivates CPU 28, and possibly other components of CPU chipset 24, in order to reduce the power consumption of the computer. EC 48 is active continuously, regardless of the operational state of the CPU. In some embodiments, EC 48 also reads the keystrokes typed on a primary keyboard 52 of the computer and provides the typed input to the computer.

Computer 20 comprises an auxiliary display module 56, which is used for displaying information (referred to herein as auxiliary information) to the user when the CPU chipset is switched-off. Module 56 comprises an auxiliary display 60, on which module 56 displays the auxiliary information. Module 56 may reside on the same circuit board as CPU chipset 24 or may alternatively comprise a separate unit. The auxiliary display module comprises an auxiliary display controller 64, which processes the information to be displayed, and an auxiliary memory 68, in which controller 64 stores information and/or program code. In some embodiments, module 56 comprises an auxiliary keypad 72, using which the user can scroll, select and/or otherwise manipulate the displayed auxiliary information. Several exemplary auxiliary display module configurations are described in the references cited in the Background section above.

Auxiliary display controller 64 and CPU 28 communicate with one another using an interface 74. In some embodiments, interface 74 comprises a Universal Serial Bus (USB) interface. Alternatively, any other suitable interface, such as a Bluetooth™ link, can be used. Auxiliary display controller 64 is connected to embedded controller 48 by a communication interface 76, such as a System Management Bus (SMBus) interface, as is known in the art, or any other suitable interface.

Computer 20 is powered by a power source 78, such as a battery. In some cases, auxiliary display module 56 is powered by a separate power source (not shown in the figure).

Typically, CPU 28, embedded controller 48 and auxiliary display controller 64 comprise general-purpose processors, which are programmed in software to carry out the functions described herein. The software may be downloaded to the processors in electronic form, over network 44, for example, or it may alternatively be supplied to the processors on tangible media, such as CDROM.

In some embodiments, auxiliary display controller 64 and/or EC 48 may comprise known devices, whose software and/or hardware are modified as needed to carry out the methods described herein. For example, auxiliary display controller 64 may comprise a Windows Sideshow compatible device, such as the WPCE521L device offered by Winbond Electronics Corp. (San Jose, Calif.). EC 48 may comprise, for example, the WPC8769L device, offered by Winbond Electronics.

Elements of computer 20 that are not essential to the understanding of the principles of the present invention, such as various memory devices, storage devices and/or Input/Output (I/O) devices, have been omitted from FIG. 1 for the sake of clarity.

### Synchronization of Auxiliary Information

In many practical applications, the auxiliary information displayed by module 56 is based on data, which is received by CPU 28 from network 44. For example, module 56 may display stock quotes, exchange rates, sports results, weather forecasts or news headlines that are provided by on-line information services, e-mail messages retrieved from a mail server, and many other types of information from various sources.

Typically, CPU 28 produces the auxiliary information (or information from which the auxiliary information can be selected or derived) based on the received data, and sends the auxiliary information to auxiliary display controller 64 over interface 74. CPU 28 and/or controller 64 may convert and/or format the data received by the CPU to produce the auxiliary information. Controller 64 stores the auxiliary information in memory 68 and displays it on auxiliary display 60.

As can be appreciated from the examples described above, it is often highly desirable to keep the auxiliary information that is displayed to the user up-to-date. When CPU 28 and network interface 40 are active, the CPU can obtain up-to-date data by communicating with network 44 as desired. When CPU 28 and/or network interface 40 are switched-off, however, data is not received from network 44, and the auxiliary information displayed by module 56 may become outdated.

The data could be kept up-to-date by maintaining the CPU and network interface in the active state constantly, so that data can be received from network at any time. This method, however, would increase the power consumption of the computer and reduce its battery life intolerably.

In order to maintain the auxiliary information up-to-date while minimizing power consumption, EC 48 switches CPU 28 to the active state only intermittently. When activated, the CPU receives up-to-date data from network 44 and provides module 56 with updated auxiliary information. The EC may activate the CPU periodically, i.e., at regular intervals, or at any other suitable times. The EC may activate and deactivate other components of computer 20, such as network interface 40 and/or display 36, in order to further reduce power consumption.

In some embodiments, auxiliary display controller 64 triggers the activation process. In these embodiments, controller 64 determines that an update is desired and sends a request to EC 48 over interface 76 to activate the CPU. EC 48 activates the CPU in response to the request. Controller 64 may determine that an update is desired based on any suitable condition. For example, controller 64 may measure the length of time in which CPU 28 is switched-off. When the inactivity period exceeds a certain predetermined length, controller 64 triggers an update request. In alternative embodiments, the activation process is triggered by EC 48.

Typically, auxiliary display controller 64 notifies EC 48 when the updating process is complete, and EC switches the CPU back to the switched-off state upon receiving the notification. Alternatively, the EC can deactivate the CPU after a certain time out.

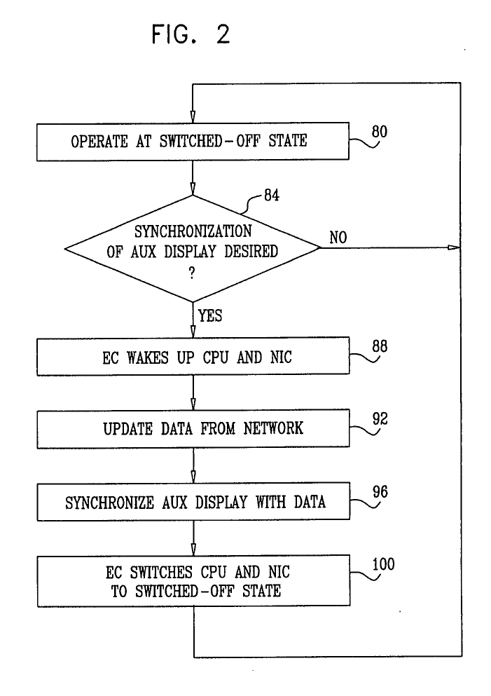

FIG. 2 is a flow chart that schematically illustrates a method for updating the auxiliary information displayed by auxiliary display module 56, in accordance with an embodiment of the present invention. The method begins with computer 20 operating in a switched-off operational state, at a switched-off operation step 80. Auxiliary display controller 64 checks whether an update of its auxiliary information is desired, at an update checking step 84. If an update is desired, controller 64 sends an update request to EC 48 over interface 76.

EC 48 wakes up CPU 28, at an activation step 88. In embodiments in which network interface 40 and/or other computer components are deactivated in the switched-off state, the EC may activate these components, as well. When activated, CPU 28 receives up-to-date data from network 44 using interface 40, at a data updating step 92. The CPU may actively request the updated data from the appropriate sources, or passively wait to receive new data.

CPU 28 updates the auxiliary information provided to auxiliary display controller 64 using the updated data, at a synchronization step 96. CPU 28 sends the updated data or the updated auxiliary information to auxiliary display controller 64 over interface 74. When controller 64 successfully receives the updated auxiliary information, it sends a deactivation request to EC 48 over interface 76. The EC switches CPU 28, and optionally other computer components, to the switched-off state, at a deactivation step 100. The method loops back to step 80 above and computer 20 continues to operate in the switched-off state until the next update cycle.

Note that in practice, the EC usually activates and deactivates the CPU for different reasons and purposes, as part of the normal operation of the computer, such as in response to user commands and activities. The methods described above can be combined with the normal operation of the computer. For example, when the CPU is activated, for any reason, the activity period can also be used to update the auxiliary information. As another example, when a user switches the computer off, the EC can initiate a process of updating the auxiliary information prior to switching off.

Although the embodiments described herein refer to a single switched-off operational state, the methods and systems described herein can be used with any number of switched-off states that differ from one another in functionality and in the conditions or events that trigger transition into and out of each state.

Although the embodiments described herein mainly address mobile computing devices, the principles of the present invention can also be used in any other computing platform in which power-saving operation is desirable. Such platforms may comprise, for example, notebooks, ultra-mobile systems, industrial PC designs, tablet PCs and many others.

Although the embodiments described herein refer to reducing the power drawn from a battery, the methods and systems described herein can also be used for reducing the power consumption from other types of power sources. For example, reducing the power drawn by a mains-powered computer can be desirable for reducing heat, reducing operational costs and increasing the reliability of the computer.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A computing apparatus, comprising:
a network interface;
a Central Processing Unit (CPU), which has active and switched-off operational states and is arranged, when operating in the active operational state, to accept data from a communication network using the network interface;
an auxiliary display module, which is connected to the CPU and is arranged, when the CPU is in the switched-off operational state, to display auxiliary information to a user based on the data accepted by the CPU; and
an activation controller, which is coupled to intermittently switch the CPU to the active operational state and to cause the CPU to update the data from the communication network, so as to update the auxiliary information displayed by the auxiliary display module.

2. The apparatus according to claim 1, wherein the auxiliary display module is arranged to evaluate an update condition and to issue to the activation controller a request for updating the auxiliary information responsively to the update condition, and wherein the activation controller is coupled to accept the request and, in response to the request, to switch the CPU to the active operational state.

3. The apparatus according to claim 2, wherein the auxiliary display module is arranged to measure a time interval in which the CPU is in the switched-off operational state and to issue the request when the time interval exceeds a predetermined limit.

4. The apparatus according to claim 1, wherein the activation controller is coupled to switch the CPU to the active operational state at regular intervals.

5. The apparatus according to claim 1, wherein the activation controller is coupled to return the CPU to the switched-off operational state immediately after the auxiliary information has been updated.

6. The apparatus according to claim 5, wherein the auxiliary display module is arranged to issue to the activation controller a notification indicating that the auxiliary information has been updated, and wherein the activation controller is coupled to return the CPU to the switched-off operational state upon receiving the notification.

7. The apparatus according to claim 1, wherein the network interface has active and switched-off operational states, and wherein the activation controller is coupled to switch the network interface to the active operational state when switching the CPU to the active operational state and to switch the network interface to the switched-off operational state when the CPU is in the switched-off operational state.

8. A computing method, comprising:
coupling a computer that comprises a Central Processing Unit (CPU), having active and switched-off operational states, to a communication network so that the CPU accepts data from the communication network when the computer is operating in the active operational state;
when the CPU is in the switched-off operational state, operating an auxiliary display module in the computer so as to display to a user auxiliary information, which is based on the data accepted by the CPU; and
intermittently switching the CPU to the active operational state by an activation controller that is separate from the CPU, and causing the CPU to update the data from the communication network, so as to update the auxiliary information displayed by the auxiliary display module.

9. The method according to claim 8, wherein operating the auxiliary display module comprises evaluating an update condition and issuing to the activation controller a request for updating the auxiliary information responsively to the update condition, and wherein intermittently switching the CPU comprises accepting the request and switching the CPU to the active operational state responsively to the request.

10. The method according to claim 9, wherein operating the auxiliary display module comprises measuring a time interval in which the CPU is in the switched-off operational state, and issuing the request when the time interval exceeds a predetermined limit.

11. The method according to claim 8, wherein intermittently switching the CPU comprises switching the CPU to the active operational state at regular intervals.

12. The method according to claim 8, wherein intermittently switching the CPU comprises returning the CPU to the switched-off operational state immediately after the auxiliary information has been updated.

13. The method according to claim 12, wherein operating the auxiliary display module comprises issuing to the activation controller a notification indicating that the auxiliary information has been updated, and wherein returning the CPU to the switched-off operational state comprises returning the CPU to the switched-off operational state upon receiving the notification.

14. The method according to claim 8, wherein the CPU accepts the data from the communication network using a network interface having active and switched-off operational states, and wherein intermittently switching the CPU further comprises switching the network interface to the active operational state when switching the CPU to the active operational state and switching the network interface to the switched-off operational state when the CPU is in the switched-off operational state.

15. A computer software product for use in a computer that includes a Central Processing Unit (CPU), which has active and switched-off operational states and is coupled to accept data from a communication network when the CPU is operating in the active operational state, and an auxiliary display module, which displays to a user auxiliary information that is based on the data accepted by the CPU, the product comprising a computer-readable medium, in which program instructions are stored, which instructions, when read by an activation controller in the computer, cause the activation controller to intermittently switch the CPU to the active operational state and to cause the CPU to update the data from the communication network, so as to update the auxiliary information displayed by the auxiliary display module.

16. The product according to claim 15, wherein the instructions cause the activation controller to accept from the auxiliary display module a request for updating the auxiliary information, and to switch the CPU to the active operational state in response to the request.

17. The product according to claim 15, wherein the instructions cause the activation controller to switch the CPU to the active operational state at regular intervals.

18. The product according to claim 15, wherein the instructions cause the activation controller to return the CPU to the switched-off operational state immediately after the auxiliary information has been updated.

19. The product according to claim 18, wherein the instructions cause the activation controller to accept from the auxiliary display module a notification indicating that the auxiliary information has been updated, and to return the CPU to the switched-off operational state upon receiving the notification.
